(19) United States
(12) Patent Application Publication
(10) Pub. No.: US 2023/0152439 A1
(43) Pub. Date: May 18, 2023

(54) MULTI-FRAME PROCESSING FOR FINE MOTION DETECTION, LOCALIZATION, AND/OR TRACKING

(71) Applicant: TEXAS INSTRUMENTS INCORPORATED, Dallas, TX (US)

(72) Inventors: Muhammet Yanik, DALLAS, TX (US); Dan Wang, ALLEN, TX (US); Adeel Ahmad, PLANO, TX (US)

(21) Appl. No.: 17/975,863

(22) Filed: Oct. 28, 2022

Related U.S. Application Data
(60) Provisional application No. 63/280,940, filed on Nov. 18, 2021.

(51) Int. Cl. G01S 13/72; G06T 7/246; G06T 7/73; G01S 7/41

(52) U.S. Cl. CPC G01S 13/726; G06T 7/248; G06T 7/74; G01S 7/415; G06T 2207/10016; G06T 2207/10028

(57) ABSTRACT

A device is provided. In some examples, the device includes a radar sensor configured to receive reflected chirps. In addition, the device includes processing circuitry configured to determine that a first object is moving. The processing circuitry is further configured to, responsive to determining that the first object is moving, determine a first location of the first object using a single frame of the reflected chirps. The processing circuitry is also configured to determine that a second object is stationary. In addition, the processing circuitry is configured to, responsive to determining that the second object is stationary, determine a second location of the second object using a plurality of frames of the reflected chirps.

This application claims the benefit of U.S. Provisional Patent Application No. 63/280,940, filed Nov. 18, 2021, the entire content being incorporated herein by reference.

### BACKGROUND

Internet of things sensors are becoming more common in buildings for uses such as safety (e.g., smoke or carbon monoxide detectors), heating, ventilation, and air conditioning (HVAC), security, comfort, and entertainment. For example, a sensor can detect motion or occupancy for an HVAC system, and the HVAC system can control temperature or air flow based on whether motion or occupancy has been detected. If a room is unoccupied, the HVAC system can conserve energy by reducing airflow to the room. As another example, a sensor can detect motion for a security system so that the security system can determine whether the building is occupied.

Traditional sensors may not be capable of accurately distinguishing between (1) stationary objects having fine motion and (2) completely non-moving objects. For example, a person within the field of view of the sensor may transition from walking to a stationary pose such as standing or sitting. Even in a stationary pose, the person will still exhibit fine motion associated with breathing, heart rate, talking, eating, or fidgeting. Table I below includes typical time periods and amplitudes of fine motion. Depending on the velocity resolution of the sensor, the sensor may lose track of the person after the person transitions the stationary pose. The sensor may be unable to distinguish the stationary person from the non-moving objects in the field of view, including the walls and furniture in a room.

TABLE I
Typical Vital Sign Parameters for Adults

| Vital | Time | Amplitude | Amplitude |
|---|---|---|---|
| signs | Period | from front | from behind |
| Breathing | 2-10 sec | ~1-12 mm | ~0.1-0.5 mm |
| Heart | 0.5-1.25 sec | ~0.1-0.5 mm | ~0.01-0.2 mm |

### SUMMARY

In some examples, a device includes a radar sensor configured to receive reflected chirps. In addition, the device includes processing circuitry configured to determine that a first object is moving. The processing circuitry is further configured to, responsive to determining that the first object is moving, determine a first location of the first object using a single frame of the reflected chirps. The processing circuitry is also configured to determine that a second object is stationary. The processing circuitry is further configured to, responsive to determining that the second object is stationary, determine a second location of the second object using a plurality of frames of the reflected chirps.

In further examples, a method includes determining that a first object is moving. The method also includes, responsive to determining that the first object is moving, determining a first location of the first object using a single frame of reflected chirps. The method further includes determining that a second object is stationary. The method includes, responsive to determining that the second object is stationary, determining a second location of the second object using a plurality of frames of the reflected chirps.

In yet further examples, a device includes a radar sensor configured to transmit a plurality of frames of chirps. The device also includes processing circuitry configured to, responsive to the radar sensor transmitting each frame in the plurality of frames of chirps, increment a counter value. The processing circuitry is further configured to determine whether the counter value equals a predetermined value. The processing circuitry is also configured to, responsive to determining that the counter value does not equal the predetermined value, run a single-frame processing mode on a most recent frame of the plurality of frames. In addition, the processing circuitry is configured to, responsive to determining that the counter value equals the predetermined value, run a multi-frame processing mode on the plurality of frames. The processing circuitry is configured to reset the counter value after running the multi-frame processing mode.

### BRIEF DESCRIPTION OF THE DRAWINGS

Features of the present invention may be understood from the following detailed description and the accompanying drawings. In that regard:

FIG. 1 is a top-view diagram of a scene including a sensor configured to determine the location of objects according to some aspects of the present disclosure.

FIG. 2 is a diagram of a room including sensors, electronic devices, and a user according to some aspects of the present disclosure.

FIGS. 3A and 3B are diagrams of the detected points for a moving object according to some aspects of the present disclosure.

FIGS. 4A and 4B are diagrams of the detected points for a stationary object with fine motion according to some aspects of the present disclosure.

FIGS. 5 and 6 are conceptual block diagrams of sensor processing systems according to some aspects of the present disclosure.

FIG. 7 is a conceptual block diagram of a device including a sensor and processing circuitry according to some aspects of the present disclosure.

FIGS. 8-10 are flow diagrams of methods for tracking moving and stationary objects with fine motion according to some aspects of the present disclosure.

FIG. 11 is a flow diagram of a method for interleaving a single-frame processing mode and a multi-frame processing mode according to some aspects of the present disclosure.

### DETAILED DESCRIPTION

Specific examples are described below in detail with reference to the accompanying figures. It is understood that these examples are not intended to be limiting, and unless otherwise noted, no feature is required for any particular example.

The detection and tracking of people using sensors has great potential in many real-world applications, including security systems, occupancy sensors, and HVAC systems. For sensors that can measure the Doppler effect, the detection and tracking of a person with dynamic motions is easier than the detection and tracking of a static person, especially in a realistic, highly cluttered environment. The main reason for this difficulty in detecting a static person is distinguishing the fine motion and/or intermittent motion of the person (e.g., breathing) from the static clutter in the environment.

To distinguish between completely stationary objects (e.g., walls and furniture) and the micro-motions on a human body, a sensor needs a finer velocity resolution. However, the velocity resolution may be limited by the available memory, the available processing power, the required frame rate, and the power consumption budget of the sensor. For frequency-modulated sensors, the velocity resolution is a function of the total chirping window and is limited within a single frame of chirps.

This disclosure describes techniques for detecting and tracking static people, even in a scene including dynamic people. These techniques can be implemented without increasing the chirping window duration in each frame and without increasing the chirping bandwidth. In accordance with the techniques of this disclosure, processing circuitry can process a single frame of chirp data to detect dynamic people, and the processing circuitry can process multiple frames of chirp data to detect the fine motion on static people. Fine motion is easier to detect across the duration of multiple frames than in the duration of a single frame. The techniques of this disclosure can be implemented without having to increase the time duration of each frame or the number of chirps in each frame.

The techniques of this disclosure may result in better performance for the sensor because single- or multi-frame processing mode can be used depending on whether there are dynamic objects or static persons present in the scene. As just one example, a sensor implementing the techniques of this disclosure can track the location of a moving person, even after the person transitions to a stationary pose. Thus, the sensor may be less likely to lose track of the stationary person. Of course, these advantages are merely examples, and no advantage is required for any particular embodiment.

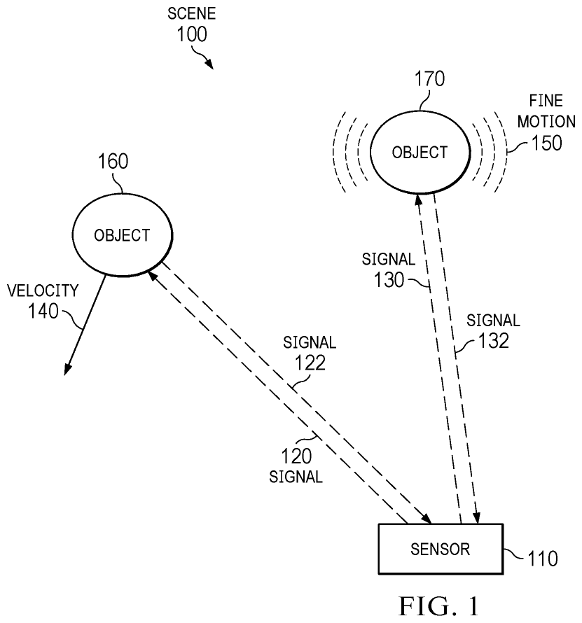

Examples of multi-frame processing for fine motion detection are described with reference to the figures below. In that regard, FIG. 1 is a top-view diagram of a scene 100 including a sensor 110 configured to determine the location of objects 160 and 170 according to some aspects of the present disclosure. Sensor 110 can be implemented as a wall-mounted sensor, a ceiling-mounted sensor, a sensor sitting on the floor of a room, a sensor sitting on a table or other furniture in a room, a sensor built into a mobile device.

Sensor 110 may be configured to transmit signals 120 and 130 and receive signals 122 and 132. Sensor 110 transmits signal 120 towards object 160, and signal 120 reflects off object 160 as signal 122. Based on received signal 122, sensor 110 can determine an estimated location of object 160. For example, sensor 110 can determine the distance between sensor 110 and a point on object 160 (i.e., the range) based on the time of travel of signals 120 and 122 and/or based on the frequency of signals 120 and 122. Sensor 110 can also determine the relative angle of object 160 (e.g., azimuth and/or elevation) based on the angle of arrival of signal 122.

FIG. 1 shows signals 120 and 130 as directional signals, but sensor 110 may be configured to transmit signals 120 and 130 as a single beam. Sensor 110 may include one or more of the following sensors: radar, lidar, ultrasound, visual light camera, infrared camera, microphone, and/or any other type of sensor. Radar sensors are especially well-suited for residential applications due to privacy concerns with cameras, but cameras are common for non-residential applications.

Object 160 is a moving object. At the instant of time shown in FIG. 1, object 160 has velocity vector 140. Sensor 110 may be configured to detect velocity vector 140 of object 160 based on the Doppler effect using the frequency of received signal 122. Sensor 110 can detect object 160 as a moving object when velocity vector 140 has a sufficient magnitude. As described in further detail below, sensor 110 may be configured to perform single-frame processing on sensed data to detect a moving object such as object 160. Sensor 110 can use a tracking algorithm such as an extended Kalman filter or an unscented Kalman filter to track moving objects.

Sensor 110 also transmits signal 130 towards object 170, and signal 132 reflects off object 170 as signal 132. Based on received signal 132, sensor 110 can determine an estimated location of object 170. For example, sensor 110 can determine the distance between sensor 110 and a point on object 170 (i.e., the range) based on the time of travel of signals 130 and 132 and/or based on the frequency of signals 130 and 132. Sensor 110 can also determine the relative angle of object 170 (e.g., azimuth and/or elevation) based on the angle of arrival of signal 132.

Object 170 is a stationary object. As a stationary object, object 170 does not have a velocity vector. Despite being a stationary object, some points on object 170 may be moving, which is shown in FIG. 1 as fine motion 150. Sensor 110 may be configured to detect fine motion 150 based on the Doppler effect using single-frame processing if the amplitude of fine motion 150 is sufficiently large. However, if the amplitude of fine motion 150 is not sufficiently large, sensor 110 may not be able to detect fine motion 150 using single-frame processing. Instead, sensor 110 may be configured to perform multi-frame processing to detect the small amplitude of fine motion 150. Fine motion 150 may have a small amplitude and a long time period, and fine motion 150 may be intermittent with pauses.

In some examples, object 170 is a person or another animal (e.g., a pet) in a stationary pose, such as standing, sitting, or lying down. Fine motion 150 may be the breathing, heartbeat, talking, eating, blinking, fidgeting, or other small-amplitude movements of the person or animal. Over the timespan of a single frame of frequency chirps, the amplitude of fine motion 150 may be too small for sensor 110 to detect fine motion 150. As non-limiting examples, a single frame of frequency chirps may have a time duration of ten milliseconds, twenty milliseconds, fifty milliseconds, one hundred milliseconds, or two hundred milliseconds. Other time durations for a single frame are possible. However, over the timespan of several frames, fine motion 150 may have a sufficiently large amplitude for sensor 110 to detect.

The detection and tracking of objects 160 and 170 can be made by processing circuitry onboard sensor 110. For example, sensor 110 may include a circuit board with processing circuitry coupled to the circuit board, where the transmitter and/or receiver of sensor 110 is coupled to the processing circuitry through the circuit board. Although this disclosure describes processing, detection, and tracking performed by sensor 110, these operations may instead be made by processing circuitry that is remote from sensor 110, such as a computing system in the cloud. For example, sensor 110 may transmit data to remote processing circuitry, where the data indicates characteristics of the signal received by sensor 110. The connection between sensor 110 and the remote processing circuitry may include a wired connection, Wi-Fi, Bluetooth, or any other communication means. As another example, processing circuitry onboard sensor 110 can determine the location of objects 160 and 170 and transmit the determined locations to remote processing circuitry for further processing and tracking of object 160 and 170.

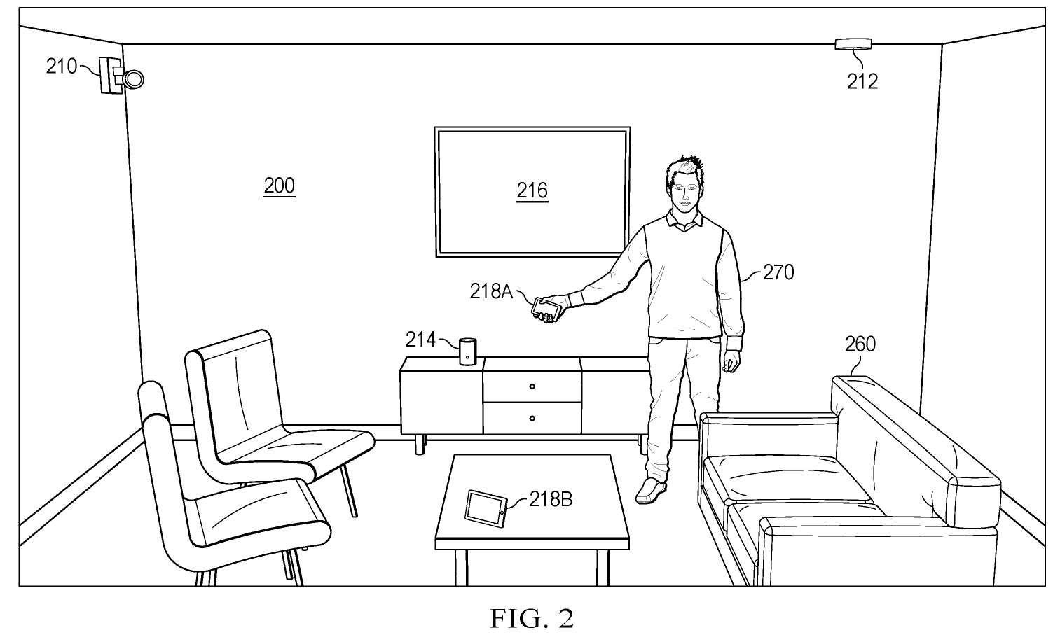

FIG. 2 is a diagram of a room 200 including sensors 210 and 212, electronic devices 214, 216, 218A, and 218B, and a user 270 according to some aspects of the present disclosure. In the example shown in FIG. 2, sensor 210 is mounted on a wall of room 200, and sensor 212 is mounted on the ceiling in room 200. Electronic device 214 is a smart home hub, electronic device 216 is a smart television mounted on a wall, and electronic devices 218A and 218B are mobile devices. Sensors 210 and 212 and electronic devices 214, 216, 218A, and 218B may be communicatively coupled to other devices or systems via Wi-Fi, Bluetooth, ethernet, etc.

Any sensor in room 200 can be used to detect objects in room 200. For example, any of the following devices may include the functionality described in this disclosure for determining the location of a wall: a motion sensor, an occupancy sensor, a smoke detector, a carbon monoxide detector, a smart home hub, a smart speaker, an exhaust fan, a security sensor, a ceiling fan, an electrical outlet, any other internet of things device, or any other electronic device. Accordingly, the techniques of this disclosure can be implemented by sensor 210 or 212 or electronic device 214, 216, 218A, or 218B.

In some examples, the functionality described in this disclosure for detecting fine motion in objects is spread across two or more devices. For example, sensor 210 may be configured to sense objects such as user 270 and furniture 260 in room 200, and one of electronic devices 214, 216, 218A, or 218B may be configured to process the sensed data and detect objects. Alternatively, one of electronic devices 214, 216, 218A, or 218B may be configured to sense objects and transmit data to a security system or an HVAC system for further processing to process the sensed data and detect objects.

Sensors 210 and 212 and electronic devices 214, 216, 218A, and 218B are located at various locations in room 200. Sensors 210 and 212 and electronic devices 214, 216, 218A, and 218B are oriented at various angles in room 200. For example, sensor 210 is installed high on a wall near a corner with a boresight oriented towards the center of room 200. Sensor 212 is installed on a ceiling and may include a sensor with a 360-degree field of view. Smart home hub 214 is sitting on a table and may include a sensor with a 360-degree field of view.

Additional example details of sensor object detection can be found in commonly assigned U.S. Pat. No. 11,412,937, entitled “Multi-Person Vital Signs Monitoring Using Millimeter Wave (mm-Wave) Signals,” issued on Aug. 16, 2022, and U.S. patent application Ser. No. 17/388,954, entitled “Method and Apparatus for Low Power Motion Detection,” filed on Jul. 29, 2021, each of which is incorporated by reference in its entirety.

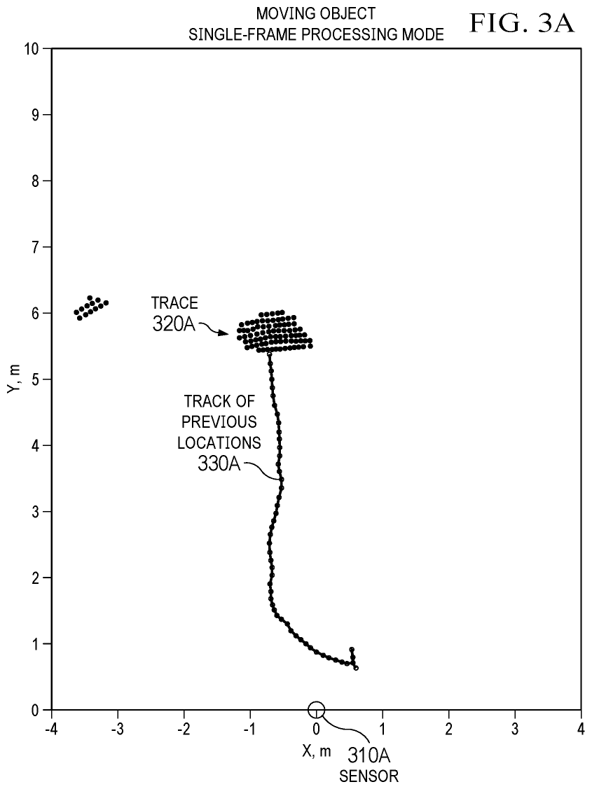

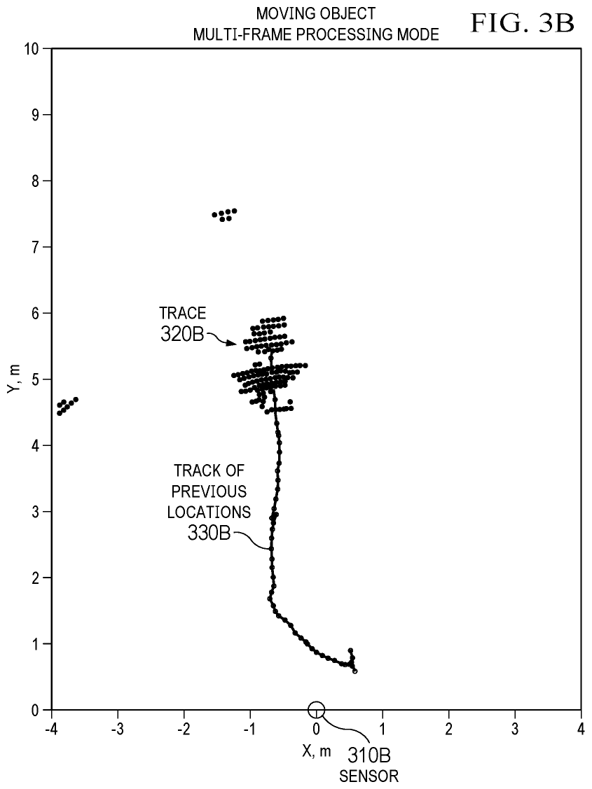

FIGS. 3A and 3B are diagrams of the detected points for a moving object according to some aspects of the present disclosure. To detect moving objects within a field of view of sensor 310A or 310B, processing circuitry may be configured to first process the data sensed by the respective sensor 310A or 310B by, for example, running a Fast Fourier Transform (FFT) algorithm and/or similar means for spectrum estimation (e.g., minimum variance distortionless response) on the sensed data. Then, the processing circuitry can search through the sensed data for points (e.g., range bins) that exhibit nonzero velocity based on the Doppler signature of those points.

In FIG. 3A, trace 320A represents the points that the processing circuitry has categorized as dynamic. In FIG. 3B, trace 320B represents the points that the processing circuitry has categorized as dynamic. The processing circuitry may be configured to categorize a point as dynamic in response to determining that the point is associated with a velocity that exceeds a threshold level. Traces 320A and 320B represent the locations of the moving arms, legs, and torso of a person who is walking.

FIGS. 3A and 3B show traces 320A and 320B after the processing circuitry (e.g., in sensors 310A and 310B) has removed the static clutter, which includes stationary objects such as walls, flooring, ceiling, furniture, and other non-moving objects. The processing circuitry may be configured to distinguish the moving objects from the static clutter based on the Doppler information in the signals received by sensors 310A and 310B.

Tracks 330A and 330B represent the locations of the person in previous frames. For each processing run, the processing circuitry may be configured to categorize a set of points as associated with an object and then to determine the centroid of that set of points. Processing circuitry can calculate the centroid location based on a previous centroid location, a previous centroid velocity, current measurements, and a motion model such as a Newton motion model. For every iteration, the processing circuitry can use a state transition model to generate a future estimate based on previous data and the current measurements. The processing circuitry may be configured to implement gating/association logic to determine which points to associate with the track. The processing circuitry can set the new centroid as the mean of the associated points. The movement of the centroid location over time is shown as tracks 330A and 330B of previous locations. The use of a centroid location is just one example—the processing circuitry may use other methods of generating tracks 330A and 330B. Additional example details of tracking object movement can be found in commonly assigned U.S. Patent Application Publication No. 2021/0405178, entitled “Tracking Radar Targets Represented by Multiple Reflection Points,” filed on Jun. 24, 2020, which is incorporated by reference in its entirety.

Although traces 320A and 320B shown in FIGS. 3A and 3B represent the same object, the traces 320A and 320B have different shapes. Trace 320A is more compact than trace 320B, and trace 320B is more dispersed and spread out than trace 320A. Using a single-frame processing mode, the processing circuitry generates trace 320A based on sensed data that spans fifty or one hundred milliseconds, in some examples. In contrast, the processing circuitry generates trace 320B using a multi-frame processing mode based on sensed data that spans five hundred milliseconds, one second, or two seconds, in some examples. These time spans for single-frame processing and multi-frame processing are merely examples to explain how the number of frames used in a processing mode affects the trace generated by the processing mode. Other time spans and time durations for the single-frame and multi-frame processing modes may be used according to the techniques of this disclosure.

When a dynamic object is present in the field of view of a sensor, using a single-frame block should generate enough dynamic points to track that dynamic object as long as the single-frame processing mode has sufficient velocity resolution to detect major motions. Further, using a single-frame processing mode, the processing circuitry may generate a more accurate estimate of the location of a moving object, as compared to the estimate that would be generated using the multi-frame processing mode.

Multi-frame processing mode creates a longer effective chirping window than single-frame processing mode, which can cause artifacts for dynamic objects. Within this longer chirping window, the dynamic object will move a greater distance and the generated point cloud will be spread in the spatial domain. In other words, when a person has high dynamicity (e.g., a velocity of one meter per second), processing across multiple frames causes a spread in the spatial domain data of trace 320B. The processing circuitry may experience degraded performance when using a multi-frame processing mode to track a moving object because the processing circuitry may incorrectly create multiple tracks for the single object represented by trace 320B. Thus, using multi-frame processing mode to track dynamic objects may result in m is-tracked objects. For at least this reason, the processing circuitry may be configured to refrain from tracking dynamic objects using multi-frame processing mode.

To avoid this error in multi-frame processing mode, the processing circuitry may be configured to remove or filter out the points associated with high Doppler speed. If the high-speed points were removed from FIG. 3B, the scene may appear empty because the only moving object has a sufficiently high speed.

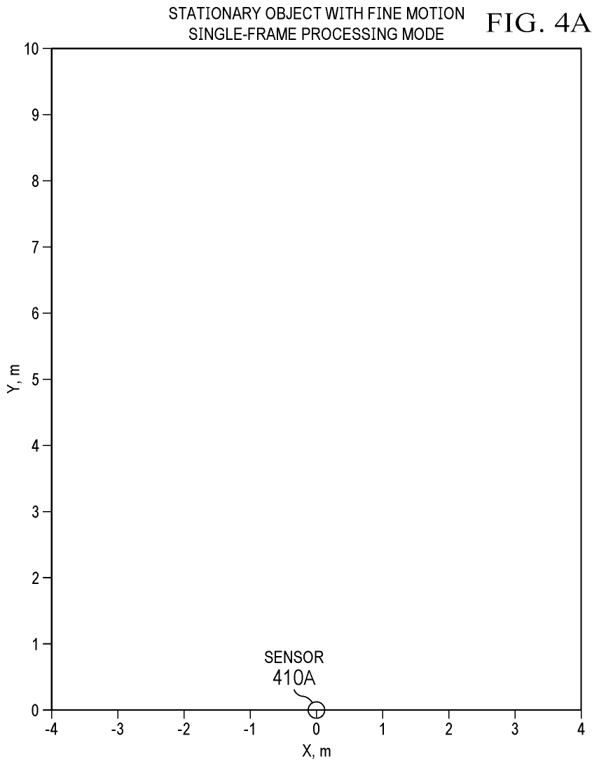

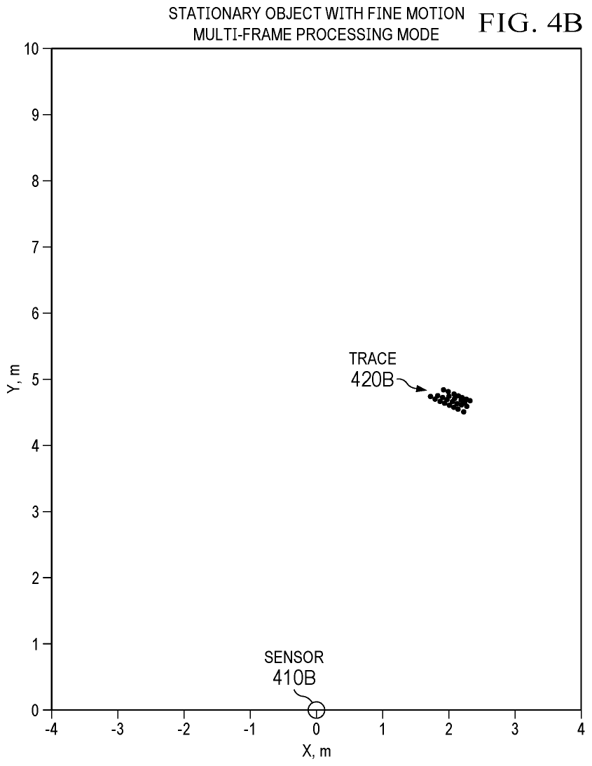

FIGS. 4A and 4B are diagrams of the detected points for a stationary object with fine motion according to some aspects of the present disclosure. Whereas the person represented in FIGS. 3A and 3B was moving (e.g., walking, running, or jumping), the person is stationary (e.g., standing, sitting, or lying down) with fine motion such as breathing, heartbeat, talking, eating, or other small movements. Thus, it is more difficult for the processing circuitry to distinguish the person from the static clutter in the field of view of sensors 410A and 410B.

No points are shown in FIG. 4A because the processing circuitry has not detected any motion in single-frame processing mode, despite the fine motion that is present. FIG. 4A shows the points associated with motion after the processing circuitry has removed the static clutter, which includes stationary objects within the field of view of sensor 410A such as walls, flooring, ceiling, furniture, and other non-moving objects.

When a static object is present in the field of view of a sensor, using a single-frame block may not generate enough dynamic points to track that static object due to insufficient velocity resolution, caused by the relatively short duration of a single frame. The time span of sensed data used by the processing circuitry in the single-frame processing mode may not be sufficient for the processing circuitry to detect any motion in the field of view of sensor 410A. Using a single frame, the processing circuitry may create insufficient information for a static track, such as person who is standing or sitting. For example, the sensed data used in the single-frame processing mode may correspond to a time duration between inhalation and exhalation by the person. Thus, the processing circuitry may not be able to detect the fine motion of breathing using the single-frame processing mode. The processing circuitry may lose the track of the object after some time because the processing circuitry does not have sufficient information to keep that track alive.

In FIG. 4B, trace 420B represents the points that the processing circuitry, operating in multi-frame processing mode, has identified as moving. The time span of sensed data used by the processing circuitry in the multi-frame processing mode may be much longer than the time span of sensed data used by the processing circuitry in the single-frame processing mode (e.g., five, ten, or twenty times longer). In some examples, the time span used for the multi-frame processing mode may be configurable such that the processing circuitry or a user can adjust this time span. Thus, the processing circuitry can generate more points for a stationary object in multi-frame processing mode.

Using multi-frame processing to detect a stationary object with fine motion, the processing circuitry may not experience the drawbacks of using multi-frame processing to detect a moving object. For example, the points in trace 420B are not spread across a large area, so the processing circuitry is less likely to categorize the points in trace 420B as two separate tracks. Even though the processing circuitry may use an equal time span for generating traces 320B and 420B, the points in trace 420B cover a smaller area than the points in trace 320B because a centroid of the object associated with trace 420B has zero velocity (or a very small velocity). Thus, multi-frame processing mode is less likely to create artifacts for stationary objects than for fast moving objects.

Although FIGS. 4A and 4B do not depict any tracks associated with the fine-motion objects, the processing circuitry may store a track for each stationary object with fine motion. The stored track may indicate that the centroid location of the stationary object has not moved substantially during the duration of the track. The stored track may include an indication of the object's movement before the object became stationary (i.e., where the person walked before sitting down).

In accordance with the techniques of this disclosure, the processing circuitry may be configured to estimate the speed of an object based, for example, on the track of the object (e.g., track 330A or 330B). Based on this estimate of speed, the processing circuitry can decide which processing mode to implement for tracking the object. The processing circuitry may be configured to select a single-frame processing mode for tracking dynamic (i.e., moving) objects and to select a multi-frame processing mode for tracking stationary objects with fine motion. The processing circuitry may be further configured to select a single-frame processing mode for tracking stationary objects with fast, large-amplitude motion, such as a rotating fan or a person riding a stationary bicycle.

In some examples, multi-frame processing mode may detect too many stationary objects because the processing circuitry may detect too many points when a long time duration is used. The processing circuitry may be configured to increase the confidence level for categorizing points as a track in multi-frame processing mode in response to determining that the number of stationary objects exceeds a threshold level. For example, if the processing circuitry detects zero objects in single-frame processing mode and detects ten objects in multi-frame processing mode, the processing circuitry may be configured to increase the confidence level required to set a new track or to maintain an existing track.

Additionally or alternatively, the processing circuitry may be configured to refrain from creating new tracks in the multi-frame processing mode. A stationary object with fine motion should not appear in the middle of the field of view of sensor 310B. A stationary object with fine motion should transition from a dynamic object somewhere in the field of view. For this reason, the processing circuitry may be configured to create tracks using only the single-frame processing mode, in some examples. Instead of creating new tracks with multi-frame data, the processing circuitry can use the multi-frame processing mode to keep a track alive when the associated object transitions from dynamic to static.

In examples in which the processing circuitry decides to implement a multi-frame processing mode, the processing circuitry can also decide the number of frames, the number of chirps in each frame, or which frames and/or chirps to use in tracking the object. The number of frames, the number of chirps in each frame, and/or the selection of frames may be software-configurable. The processing circuitry may be configured to subsample the chirps stored in a multi-frame memory block to achieve a better Doppler granularity with less maximum unambiguous velocity. In addition, the processing circuitry can also decide the number of chirps to use in tracking an object in single-frame processing mode.

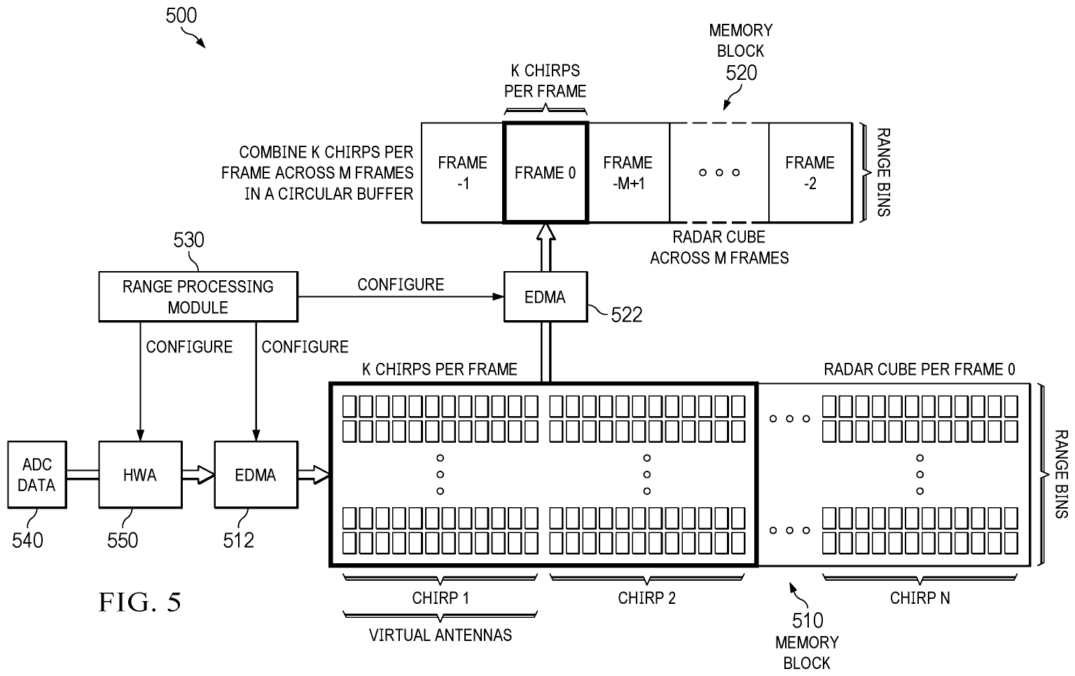

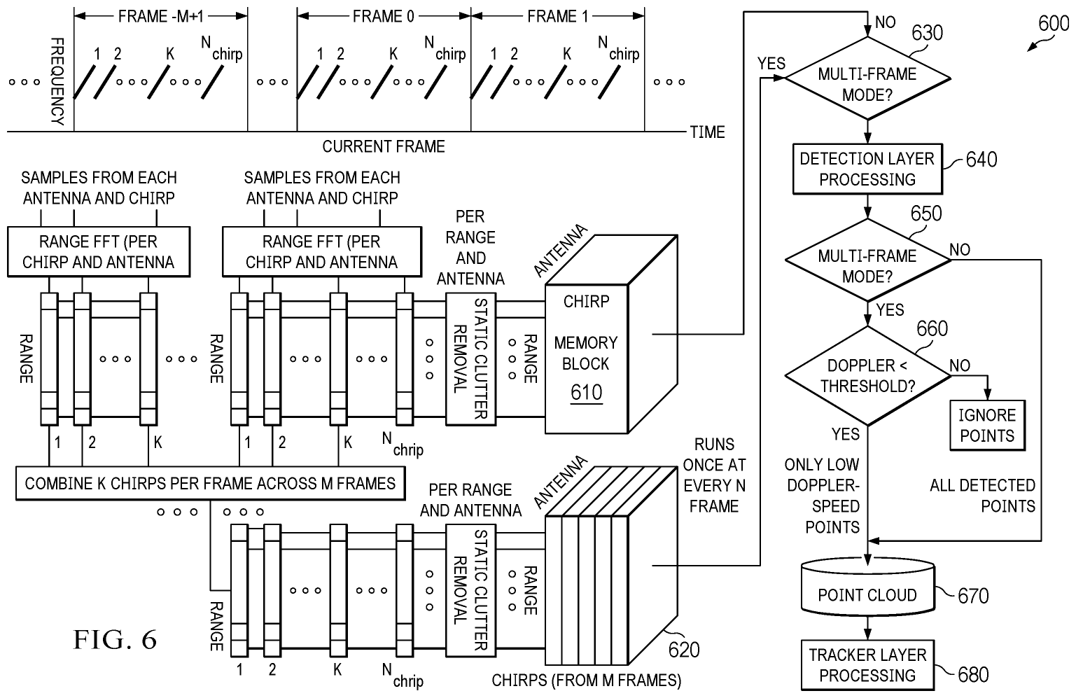

FIGS. 5 and 6 are conceptual block diagrams of sensor processing systems 500 and 600 according to some aspects of the present disclosure. The components and modules shown in FIGS. 5 and 6 are merely examples for performing the functionality described in this disclosure, and other components and modules not shown in FIGS. 5 and 6 can be used to perform this functionality. Sensor processing system 500 includes two memory blocks 510 and 520, which are configured to store sensed data for object detection and velocity determinations.

Sensor processing system 500 includes processing circuitry, such as range processing module 530, configured to run a single-frame processing mode on the sensed data stored in memory block 510 to detect a moving object. The processing circuitry may be configured to also run a multi-frame processing mode on the sensed data stored in memory block 520 to detect a stationary object with fine motion. Although FIG. 5 depicts range processing module 530, processing circuitry in sensor processing system 500 may be configured to perform interference mitigation, decoding of binary phase modulation, and/or decoding of Doppler division multiple access. Sensor processing system 500 may perform range processing before or after any of these other processing blocks. For example, sensor processing system 500 may be configured to perform interference mitigation on ADC data 540 before performing range processing on the interference mitigated data.

Memory block 520 allows for sensor processing system 500 to create a longer chirping window for detecting the minor motions of stationary objects, while memory block 510 allows for robust detection of the major motions of moving objects. The processing circuitry may be configured to run detection-layer processing on the sensed data stored in memory blocks 510 and 520 in different time slots. Memory blocks 510 and 520 may also be referred to as data cubes or radar cubes. For example, the processing circuitry may be configured to time-interleave the processing of data stored in memory blocks 510 and 520 by running the single-frame processing mode in a first time slot and running the multi-frame processing mode in a second time slot after the first time slot. The processing circuitry can run these two processing modes in a time-division mode (e.g., a time-multiplexing mode) to conserve processing resources and fit with a predefined processing budget.

Memory block 510 includes the available chirps in a current frame with an optimized velocity resolution for the detection of the highly dynamic motions. Memory block 510 may be configured to store all of the chirps from the current frame or, in some examples, a subset of all of the chirps from the current frame. In the example shown in FIG. 5, memory block 510 includes frame ‘zero,’ which includes N chirps, where N is an integer greater than one. The data stored in memory block 510 for each chirp can be organized by range bin and virtual antenna. Memory block 520 includes the chirp sub-blocks from the current frame and one or more previous frames to create a longer-duration chirping window for the detection of a static person with fine motion. Memory block 520 includes data for K chirps from each frame of M frames, where K is an integer greater than zero, and where M is an integer greater than one. To conserve memory, memory block 520 may include fewer than all of the chirps for each frame, i.e., the value of K may be less than the value of N.

In other words, the data stored in memory block 520 may be sparser than the data stored in memory block 510 because sensor processing system 500 may be configured to store only a subset of data in memory block 520. Sensor processing system 500 may be configured to store only K data sets out of every N data sets, where K is an integer as small as one, and N is an integer that is larger than K. Thus, to conserve memory, the data stored in memory block 520 may represent a longer time duration than the time duration represented by the data stored in memory block 510. Sensor processing system 500 may not store all of the data from the M frames shown in FIG. 5 because of the available memory may be limited. The data stored in memory block 520 may be associated with only small percentage of the total data obtained during the time duration from the oldest data in memory block 520 to the newest data in memory block 520. Thus, the data stored in memory block 520 may span a time duration of one or two seconds, during which one thousand chirps were received, but memory block 520 may store only fifty of those one thousand chirps, as just one example. The time durations and chirp counts in this disclosure are merely examples, and any other time durations and chirp counts can be used.

Range processing module 530 can configure hardware accelerator 550 to operate on the data 540 outputted by one or more analog-to-digital converters. Although hardware accelerator 550 is shown in FIG. 5, sensor processing system 500 may include a central processing unit (CPU), digital signal processor (DSP), or any other circuitry configured to perform the functionality attributed herein to hardware accelerator 550. Hardware accelerator 550 is just one example of how this functionality can be implemented. Hardware accelerator 550 outputs the chirp data stored in memory blocks 510 and 520. Range processing module 530 may be configured to control enhanced direct memory accesses (EDMAs) 512 and 522 to store data in memory blocks 510 and 520. In addition, range processing module 530 can configure EDMA 512 to store the data in memory block 510 at a first location in memory and can configure EDMA 522 to store the data in memory block 520 at a second location in memory.

Memory block 520 may be arranged and filled as a circular buffer, so that new data overwrites the oldest data stored in memory block 520. After each frame, the processing circuitry may be configured to overwrite the data that is stored in memory block 510 by writing data for the new frame to memory block 510. Moreover, the processing circuitry may be configured to overwrite the oldest data that is stored in memory block 520. For example, if memory block 520 is configured to store data associated with twenty frames, the processing circuitry may be configured to overwrite the data associated with the oldest frame in memory block 520 by writing a subset of the data for the new frame to memory block 520.

EDMA is an efficient means for transferring data to memory blocks 510 and 520. However, sensor processing system 500 can use other means for transferring data to memory blocks 510 and 520. For example, a CPU and/or a DSP can transfer or copy the contents before different memory locations without an EDMA module. Thus, sensor processing system 500 may include only one of EDMAs 512 and 522, or sensor processing system 500 may include no EDMA modules.

Sensor processing system 600 includes two memory blocks 610 and 620, which are configured to store sensed data for object detection and velocity determinations. Sensor processing system 600 includes processing circuitry configured to run a single-frame processing mode on the sensed data stored in memory block 610 to detect a moving object. The processing circuitry may be configured to also run a multi-frame processing mode on the sensed data stored in memory block 620 to detect a stationary object with fine motion.

Sensor processing system 600 can generate data for memory block 610 using samples from each antenna and chirp. Memory block 610 can store the available chirps in a current frame with an optimized velocity resolution for the detection of the highly dynamic motions. Memory block 620 can store the chirp sub-blocks from the current frame and one or more previous frames to create a longer-duration chirping window for the detection of a static person with fine motion. Sensor processing system 600 may be configured to perform static clutter removal on the chirp data before storing the static-clutter-filtered data in memory blocks 610 and 620.

Referring to decision block 630, the processing circuitry of sensor processing system 600 determines whether to implement a multi-frame processing mode. If the processing circuitry implements the multi-frame processing mode, the processing circuitry retrieves data stored in memory block 620. If the processing circuitry does not implement the multi-frame processing mode, the processing circuitry retrieves data stored in memory block 610.

Using decision block 630, the processing circuitry processes the chirp data stored in memory blocks 610 and 620 in a time-division mode, which may conserve processing resources. In other words, the processing circuitry may be configured to time-interleave the single-frame processing mode and the multi-frame processing mode. In some examples, the processing circuitry is configured to perform the single-frame processing mode for a plurality of consecutive frames without performing the multi-frame processing mode. The processing circuitry may then perform the multi-frame processing mode every third, fifth, tenth, or twentieth frame. These intervals are merely examples, and any interval may be used for the multi-frame processing mode. Moreover, the processing interval for the multi-frame processing mode may be configurable by the processing circuitry and/or by the user. The design choice of how often to perform the multi-frame processing mode is related to the design choice of how many frames of chirp data to store in memory block 620. Additionally or alternatively, these parameters may be software-configurable, and the number of frames stored in memory block 620 is not necessarily equal to frame rate of the multi-frame processing mode.

The processing circuitry performs additional detection layer processing 640. This processing may include the processing circuitry determining the azimuth angle and/or elevation angle for each point in a range bin, performing Doppler processing, and/or running a constant false alarm rate (CFAR) algorithm to detect objects. As implemented by the processing circuitry, the detection layer processing may include angle processing, Doppler processing, and detection processing. The processing circuitry may be configured to apply the same detection layer processing to the data stored in memory blocks 610 and 620.

Referring to decision block 650, the processing circuitry determines whether multi-frame processing mode is being performed. Referring to block 660, if the multi-frame processing mode is being performed, the processing circuitry determines whether the Doppler information (e.g., speed) associated with each point is less than a threshold value.

In response to determining that the Doppler information associated with a point is not less than the threshold value at block 660, the processing circuitry ignores (e.g., discards) the point for purposes for tracking objects. Points having high Doppler-speed are not useful in multi-frame processing mode because a high-speed object can travel a sufficiently large distance during the multiple frames. A single object (e.g., especially dynamic tracks) spanning a large distance can create artifacts, confusing the processing circuitry into incorrectly categorizing the single object as multiple objects.

In response to determining that the Doppler information associated with a point is less than the threshold value at block 660, the processing circuitry adds the point to point cloud 670. Referring back to block 650, if the single-frame processing mode is being performed, the processing circuitry adds all of the points detected in the single-frame processing mode to point cloud 670. Thus, point cloud 670 includes the low-speed detected points from the multi-frame processing mode and all of the detected points from the single-frame processing mode. Point cloud 670 may not include any of the completely stationary objects because the processing circuitry had previously removed the static clutter from memory blocks 610 and 620.

The processing circuitry implements tracker layer processing 680 on point cloud 670 to develop and update tracks of detected objects. The processing circuitry can associate a set of points within point cloud 670 with an existing track based on the most recent location and speed of that track. The processing circuitry may be configured to implement a tracking algorithm such as an extended Kalman filter to determine which points in point cloud 670 should be associated with a given track. Additionally or alternatively, the processing circuitry can perform gating/association by computing the distance metrics of each detected point and determining whether to associate each point with a track.

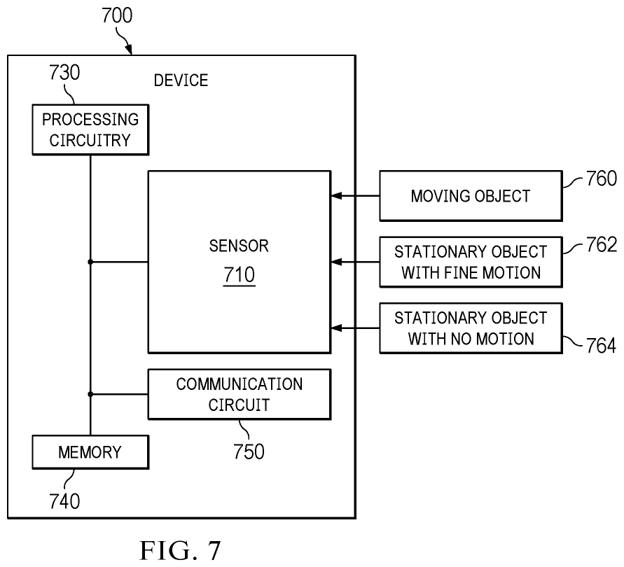

FIG. 7 is a conceptual block diagram of a device 700 including a sensor 710 and processing circuitry 730 according to some aspects of the present disclosure. In the example shown in FIG. 7, device 700 includes sensor 710, processing circuitry 730, memory 740, and communication circuit 750. Device 700 may be configured as or be part of a motion sensor, an occupancy sensor, a smoke detector, a carbon monoxide detector, a smart home hub, a smart speaker, an exhaust fan, a security sensor, a ceiling fan, an electrical outlet, any other internet of things device, or any other electronic device. Device 700 may be configured to mount on a wall or ceiling of a room. Additionally or alternatively, device 700 may be configured to rest on a table or the ground, or device 700 may be a mobile device that is held by a user.

Sensor 710 may include a continuous wave radar sensor, a pulsed radar sensor, a lidar sensor, an ultrasonic sensor, a visual light camera, an infrared camera, a microphone, and/or any other type of sensor. In examples in which sensor 710 includes a radar, the radar may be a low-resolution internet-of-things radar sensor including one or more (e.g., three) transmitter channels and one or more (e.g., four) receiver channels. The techniques of this disclosure may be implemented by a low-resolution radar to achieve object-detection accuracy on par with a more expensive multiple-input multiple-output phased array radar. Additional example details of object detection can be found in commonly assigned U.S. patent application Ser. No. 17/876,927, entitled “Room Boundary Detection,” filed on Jul. 29, 2022, which is incorporated by reference in its entirety.

Processing circuitry 730 may be configured to determine the location of objects 760, 762, and 764 based on signals received by sensor 710. To determine the location and velocity of a moving object, for example, processing circuitry 730 may be configured to apply a Kalman filter and/or another tracking algorithm (e.g., multiple-hypothesis tracking) to the signals received by sensor 710.

Processing circuitry 730 may be configured to also perform the single-frame processing and multi-frame processing described with respect to FIGS. 3-6. Alternatively, the single-frame processing and multi-frame processing may be performed by processing circuitry that is remote from device 700. In such examples, communication circuit 750 can send, to the remote processing circuitry, data indicating the signals received by sensor 710.

Memory 740 may be configured to store data relating to the locations and velocities of objects 760, 762, and 764. Memory 740 can store chirp data in one or more memory blocks, such as a first memory block for single-frame processing mode and a second memory block for multi-frame processing mode. Memory 740 can also store a point cloud including the output of the single-frame processing mode and the output of the multi-frame processing mode. In addition, memory 740 can store instructions that, when executed by processing circuitry 730, cause processing circuitry 730 to implement a single-frame processing mode and/or a multi-frame processing mode.

Communication circuit 750 may be configured to transmit and receive data with other electronic devices using Wi-Fi, Bluetooth, Zigbee, ethernet, or another type of communication. Communication circuit 750 can transmit data indicating the signals received by sensor 710, objects detected by processing circuitry 730, and/or the outputs of a single-frame processing mode or a multi-frame processing mode.

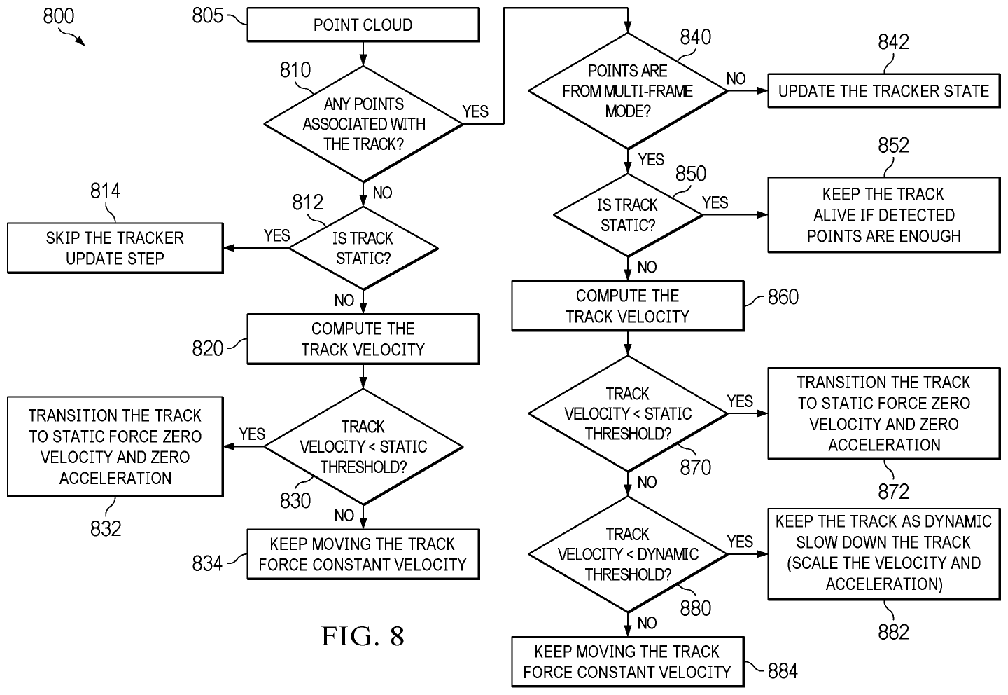

FIGS. 8-10 are flow diagrams of methods for tracking moving and stationary objects with fine motion according to some aspects of the present disclosure. Some processes of the methods 800, 900, and 1000 may be performed in orders other than described, and many processes may be performed concurrently in parallel. Furthermore, processes of the methods 800, 900, and 1000 may be omitted or substituted in some examples of the present disclosure. The methods 800, 900, and 1000 are described with reference to device 700 shown in FIG. 7, although other components such as sensors 110, 210, 212, 310A, 310B, 410A, and 410B and electronic devices 214, 216, 218A, and 218B may exemplify similar techniques.

Referring to decision block 810, for a particular track, processing circuitry 730 determines whether there are any points in point cloud 805 that are associated with that particular track. To determine whether a first point in point cloud 805 is associated with a track, processing circuitry 730 can compare the location of the first point to the expected location of the tracked object. Processing circuitry 730 can determine the expected location of the tracked object using a tracking algorithm, such as an extended Kalman filter or a multiple-hypothesis tracking algorithm.

In response to determining that there are no points in point cloud 805 associated with the particular track, processing circuitry 730 proceeds to decision block 812 and determines whether the particular track is static. Processing circuitry 730 can determine that the track is static by determining that the track is associated with a velocity less than a defined threshold. This defined threshold can be zero, close to zero, and/or configurable in software (e.g., by processing circuitry 730 and/or by a user). In response to determining that the particular track is static, processing circuitry 730 skips the tracker update step and leaves the location and velocity of the track unchanged, referring to block 814. Processing circuitry 730 may also increment a static-to-free counter in response to determining that the particular track is static in decision block 812. Processing circuitry 730 can reset the counter at block 852 in multi-frame processing mode.

In response to determining that the particular track is not static in decision block 812, processing circuitry 730 proceeds to block 820 and computes the track velocity. Processing circuitry 730 can compute a track velocity based on previous centroid estimations (e.g., location and velocity) of the tracked object and the current measurements (e.g., Doppler information). In other words, processing circuitry 730 may be configured to determine the track velocity based on Doppler information in the sensed data and/or based on the movement of the object over time.

Referring to decision block 830, processing circuitry 730 determines whether the track velocity is less than a static threshold value. In response to determining that the track velocity is less than the static threshold value, processing circuitry 730 transitions the particular track to static by setting the velocity and acceleration of the track to zero, referring to block 832. In response to determining that the track velocity is not less than the static threshold value in decision block 830, processing circuitry 730 keeps the particular track moving by, for example, setting the velocity to a constant value, referring to block 834. Setting the velocity to a constant value may reduce the likelihood of an incorrect decision.

In response to determining that there at least one point in point cloud 805 is associated with the particular track, processing circuitry 730 proceeds to decision block 840 and determines whether the associated points originated from multi-frame processing mode. In response to determining that the associated points did not originate from multi-frame processing mode, processing circuitry 730 updates the tracker state, referring to block 842. If the associated points originated from single-frame processing mode, processing circuitry 730 can use the associated points to update the particular track without performing the functionality in blocks 850, 852, 860, 870, 872, 880, 882, and 884. Points originating single-frame processing mode are less likely to include artifacts than points originating multi-frame processing mode.

In response to determining that the associated points originated from multi-frame processing mode, processing circuitry 730 proceeds to decision block 850 and determines whether the particular track is static. In response to determining that the particular track is static, processing circuitry 730 keeps the static track alive if there are a sufficient number of points associated with the particular track and if the points are close enough to the track location, referring to block 852. Processing circuitry 730 may also reset the static-to-free counter in response to determining that the particular track is static in decision block 850.

In response to determining that the particular track is not static in decision block 850, processing circuitry 730 proceeds to block 860 and computes the track velocity. Referring to decision block 870, processing circuitry 730 determines whether the track velocity is less than a static threshold value. In response to determining that the track velocity is less than the static threshold value, processing circuitry 730 transitions the particular track to static by setting the velocity and acceleration of the track to zero, referring to block 872.

In response to determining that the track velocity is not less than the static threshold value in decision block 870, processing circuitry 730 proceeds to decision block 880 and determines whether the track velocity is less than a dynamic threshold value. In response to determining that the track velocity is less than the dynamic threshold value in decision block 880, processing circuitry 730 proceeds to block 882 and keeps the particular track as dynamic and scales down the velocity and acceleration of the particular track based on the associated points. Processing circuitry 730 can reduce the track velocity because the associated points originated from the multi-frame processing mode, and processing circuitry 730 may have already removed the high-speed points from the multi-frame processing mode (see, e.g., block 660 shown in FIG. 6).

In response to determining that the track velocity is not less than the dynamic threshold value in decision block 880, processing circuitry 730 proceeds to block 884 and keeps the particular track moving by, for example, setting the velocity to a constant value, referring to block 884. Although not shown in FIG. 8, processing circuitry 730 may be configured to run the multi-frame processing mode only in response to determining that a track is static. Processing circuitry 730 can run the multi-frame processing mode at a lower rate, e.g., every N frames using a subset of chirps from M consecutive frames, where N and M are integers greater than one, and where N may be equal to M. In response to determining that all of the tracks are dynamic, processing circuitry 730 may be configured to only run the single-frame processing mode.

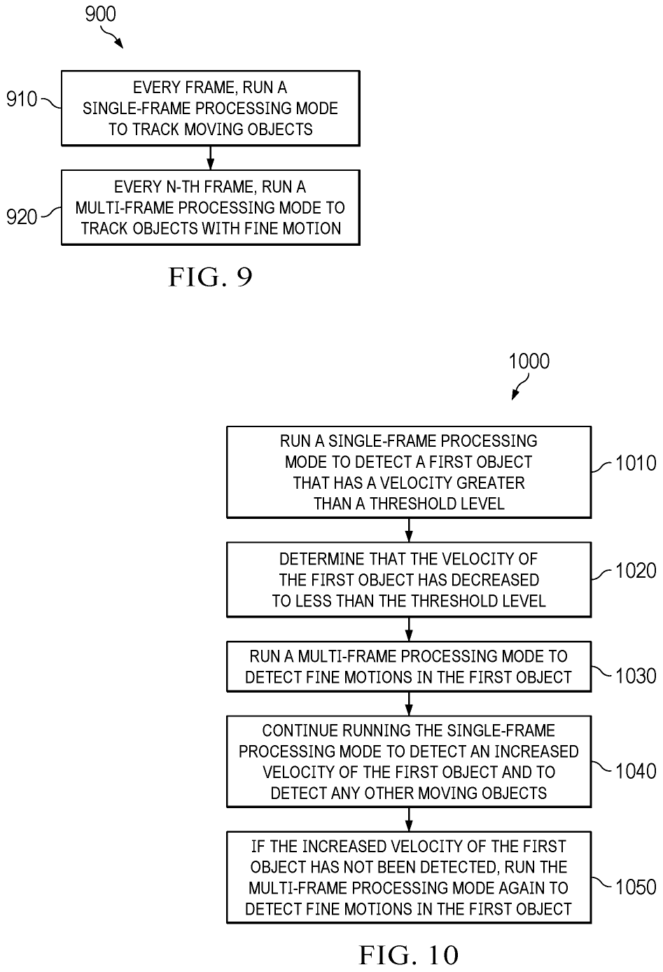

Method 900 shown in FIG. 9 includes the two processing modes for detecting objects. Referring to block 910, every frame, processing circuitry 730 runs a single-frame processing mode to track moving objects. In implementing the single-frame processing mode, processing circuitry 730 may be configured to use data from all of the chirps in the most recent frame. Alternatively, in implementing the single-frame processing mode, processing circuitry 730 may be configured to use data from a subset of the chirps in the most recent frame. Single-frame processing may be well-suited for detecting moving objects because of the relatively short duration of each frame. However, single-frame processing may not be well-suited for detecting fine motion or intermittent motion because of that relatively short duration.

Referring to block 920, processing circuitry 730 runs a multi-frame processing mode to track objects with fine motion. Processing circuitry 730 can use the multi-frame processing mode to localize and track stationary objects (e.g., objects with zero centroid velocity) and slow-moving objects (e.g., objects with centroid velocity less than a threshold value). In implementing the multi-frame processing mode, processing circuitry 730 may be configured to use data from a subset of the chirps in a plurality of the most recent frames. The subset of chirps may be as few as a single chirp from each of the plurality of frames. Multi-frame processing may be well-suited for detecting fine motion or intermittent motion because of the relatively long duration of the plurality of frames. However, multi-frame processing may not be well-suited for moving objects because the relatively long duration spreads out the detected points, possibly resulting detecting phantom objects.

Processing circuitry 730 may be configured to choose between the single-frame processing mode and the multi-frame processing mode. Multi-frame processing mode may be well-suited to detect fine motion even in a complex scene with objects having different velocities. Even in complex scenes, processing circuitry running a multi-frame processing mode may be capable of distinguishing fine motion and intermittent motion from the static clutter. These capabilities are especially useful for applications such as motion detection, occupancy detection, people counting, security systems, and the like.

Method 1000 shown in FIG. 10 includes techniques for detecting an object as the velocity of the object changes over time. Referring to block 1010, processing circuitry 730 runs a single-frame processing mode to detect a first object that has a velocity greater than a threshold level. Processing circuitry 730 can determine the velocity based on the Doppler information in sensed data and/or based on the movement of the location of the object over time.

Referring to block 1020, processing circuitry 730 determines that the velocity of the first object has decreased to less than the threshold level. The designer or user may select the threshold level such that, for example, single-frame processing mode is better-suited for detecting velocities greater than the threshold level, and multi-frame processing mode is better-suited for detecting velocities less than the threshold level.

In response to determining that the velocity of the first object has decreased to less than the threshold level, processing circuitry 730 runs a multi-frame processing mode to detect fine motions in the first object, referring to block 1030. Device 700 may store the data from a plurality of consecutive frames in a block of memory 740 that is separate from the block where the single-frame data is stored. Referring to block 1040, processing circuitry 730 may be configured to continue to run the single-frame processing mode even when the velocity of the first object has decreased to less than the threshold level. Processing circuitry 730 can run the single-frame processing mode to detect moving objects, including the first object if the velocity of the first object increases above the threshold level.

Referring to block 1050, processing circuitry 730 runs the multi-frame processing mode in response to determining that the velocity of the first object has not increased to greater than the threshold level. To fit both processing modes into a predefined processing budget, processing circuitry 730 may wait several frames between each run of the multi-frame processing mode. Running the multi-frame processing mode allows for processing circuitry 730 to generate fresh data to keep static tracks alive.

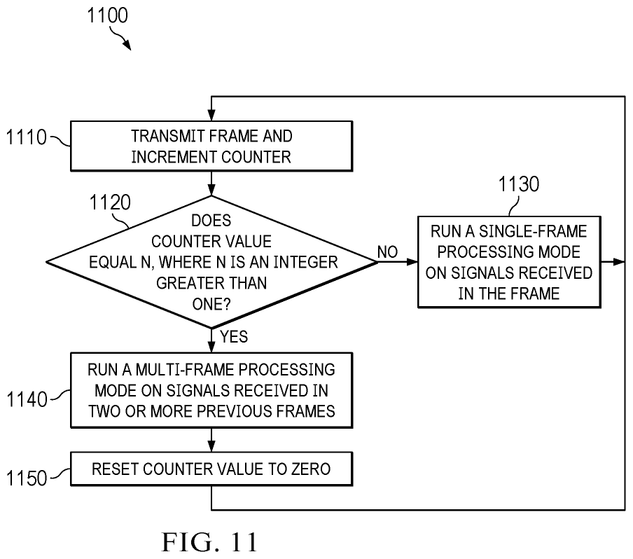

FIG. 11 is a flow diagram of a method for interleaving a single-frame processing mode and a multi-frame processing mode according to some aspects of the present disclosure. Some processes of the method 1100 may be performed in orders other than described, and many processes may be performed concurrently in parallel. Furthermore, processes of the method 1100 may be omitted or substituted in some examples of the present disclosure. The method 1100 is described with reference to device 700 shown in FIG. 7, although other components such as sensors 110, 210, 212, 310A, 310B, 410A, and 410B and electronic devices 214, 216, 218A, and 218B may exemplify similar techniques.

Referring to block 1110, processing circuitry 730 causes sensor 710 to transmit a frame of chirps and increment a counter. The signals in the frame of chirps will reflect off one or more objects on the field of view of sensor 710, and sensor 710 will receive the reflections of the signals. Processing circuitry 730 may be configured to store the data from the current frame of reflected chirps in a single-frame memory block by overwriting data from the most recent frame stored in a first memory block. In addition, processing circuitry 730 may be configured to store a portion of the data from the current frame of reflected chirps in a multi-frame memory block by overwriting data from an older frame.

Referring to block 1120, processing circuitry 730 determines whether the counter value equals N, where N is an integer greater than one. N may be the number of frames that are processed by processing circuitry 730 in the multi-frame processing mode. Processing circuitry 730 can run the single-frame processing mode for (N−1) consecutive frames and then run the multi-frame processing mode after the Nth frame, before repeating the loop.

Referring to block 1130, processing circuitry 730 runs a single-frame processing mode on data from signals received in the most recent frame. Unless the counter value equals N in the example shown in FIG. 11, processing circuitry 730 runs the single-frame processing mode. In the example shown in FIG. 11, processing circuitry 730 may run the multi-frame processing mode only when the counter value equals N.

Referring to block 1140, processing circuitry 730 runs a multi-frame processing mode on the data from signals received in the two or more previous frames. In some examples, processing circuitry 730 can run the multi-frame processing mode on the previous N frames. Alternatively, greater than or fewer than N frames may be used by processing circuitry 730 in the multi-frame processing mode. When the counter value equals N, processing circuitry 730 may run only the multi-frame processing mode. Alternatively, processing circuitry 730 may be configured to also run the single-frame processing mode in block 1140, before resetting the counter value.

Referring to block 1150, processing circuitry 730 resets the counter value to zero. The counter may be part of processing circuitry 730 or memory 740. Resetting the counter value to zero may cause processing circuitry 730 to run the single-frame processing mode for the next (N−1) frames. Resetting the counter value to zero may cause processing circuitry 730 to refrain from running the multi-frame processing mode for the next (N−1) frames.

Processing circuitry 730 may be configured to implement method 1100 by performing time-division on the single-frame processing mode and the multi-frame processing mode. For example, processing circuitry 730 can create a time slot after sensor 710 receives the data for each frame. During each time slot, processing circuitry 730 can perform the single-frame processing mode or the multi-frame processing mode on the stored data. After sensor 710 receives a first frame of chirps, processing circuitry 730 can perform the single-frame processing mode during a first time slot. Then, after sensor 710 receives a second frame of chirps, processing circuitry 730 can perform the multi-frame processing mode during a second time slot. This time-division approach can conserve processing resources, especially when there is insufficient time between frames to run both processing modes. Alternatively, processing circuitry 730 may be configured to perform both the single-frame processing mode and the multi-frame processing mode in a single time slot (e.g., between two successive frames).

This disclosure has attributed functionality to sensors 110, 210, 212, 310A, 3106, 410A, 4106, and 710, electronic devices 214, 216, 218A, and 2186, range processing module 530, detection layer processing 640, tracker layer processing 680, processing circuitry 730, and communication circuit 750. Sensors 110, 210, 212, 310A, 3106, 410A, 4106, and 710, electronic devices 214, 216, 218A, and 2186, range processing module 530, detection layer processing 640, tracker layer processing 680, processing circuitry 730, and/or communication circuit 750 may include one or more processors. Sensors 110, 210, 212, 310A, 3106, 410A, 4106, and 710, electronic devices 214, 216, 218A, and 2186, range processing module 530, detection layer processing 640, tracker layer processing 680, processing circuitry 730, and/or communication circuit 750 may include any combination of integrated circuitry, discrete logic circuitry, analog circuitry, such as one or more microprocessors, microcontrollers, DSPs, application specific integrated circuits, CPUs, graphics processing units, field-programmable gate arrays, and/or any other processing resources. In some examples, sensors 110, 210, 212, 310A, 310B, 410A, 410B, and 710, electronic devices 214, 216, 218A, and 218B, range processing module 530, detection layer processing 640, tracker layer processing 680, processing circuitry 730, and/or communication circuit 750 may include multiple components, such as any combination of the processing resources listed above, as well as other discrete or integrated logic circuitry, and/or analog circuitry.

The techniques described in this disclosure may also be embodied or encoded in an article of manufacture including a non-transitory computer-readable storage medium, such as memory 740. Example non-transitory computer-readable storage media may include random access memory (RAM), read-only memory (ROM), programmable ROM, erasable programmable ROM, electronically erasable programmable ROM, flash memory, a solid-state drive, a hard disk, magnetic media, optical media, or any other computer readable storage devices or tangible computer readable media. The term “non-transitory” may indicate that the storage medium is not embodied in a carrier wave or a propagated signal. In certain examples, a non-transitory storage medium may store data that can, over time, change (e.g., in RAM or cache).

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

It is understood that the present disclosure provides a number of exemplary embodiments and that modifications are possible to these embodiments. Such modifications are expressly within the scope of this disclosure. Furthermore, application of these teachings to other environments, applications, and/or purposes is consistent with and contemplated by the present disclosure.

What is claimed is:

1. A device comprising:
a radar sensor configured to receive reflected chirps; and
processing circuitry configured to:
determine that a first object is moving;
responsive to determining that the first object is moving, determine a first location of the first object using a single frame of the reflected chirps;
determine that a second object is stationary; and
responsive to determining that the second object is stationary, determine a second location of the second object using a plurality of frames of the reflected chirps.

2. The device of claim 1,
wherein to determine that the first object is moving, the processing circuitry is configured to determine that a first estimated velocity of the first object is greater than a threshold level, and
wherein to determine that the second object is stationary, the processing circuitry is configured to determine that a second estimated velocity of the second object is greater than the threshold level.

3. The device of claim 1, wherein to determine the second location, the processing circuitry is configured to process a subset of the reflected chirps across the plurality of frames.

4. The device of claim 1, wherein to determine the second location, the processing circuitry is configured to process a respective chirp from each frame of the plurality of frames.

5. The device of claim 1, wherein the processing circuitry is configured to run a time-division mode to interleave the processing of the single frame and the processing the plurality of frames.

6. The device of claim 1,
wherein the plurality of frames is a first plurality of frames, and
wherein the processing circuitry is configured to:
refrain from processing a second plurality of frames of the reflected chirps for at least five frames after processing the first plurality of frames; and
process the second plurality of frames to determine the second location at least five frames after processing the first plurality of frames.

7. The device of claim 6, wherein the processing circuitry is further configured to perform a single-frame processing mode after every frame to detect the first object.

8. The device of claim 1, wherein the processing circuitry is configured to:
identify, in the plurality of frames, a set of points having a first velocity exceeding a threshold level;
remove the set of points from a point cloud; and
determine the second location based on the point cloud.

9. The device of claim 8, wherein the set of points is first set of points, and wherein the processing circuitry is configured to:
identify, in the plurality of frames, a second set of points having a second velocity not exceeding the threshold level;
identify, in the single frame, a third set of points; and
add the second and third sets of points to the point cloud.

10. The device of claim 1, wherein the processing circuitry is configured to:
detect a first number of objects using the single frame;
detect a second number of objects using the plurality of frames;
determine a difference between the first and second numbers exceeds a threshold level; and
responsive to determining that the difference exceeds the threshold level, increase a confidence level for setting a new track.

11. A method comprising:
determining that a first object is moving;
responsive to determining that the first object is moving, determining a first location of the first object using a single frame of reflected chirps;
determining that a second object is stationary; and
responsive to determining that the second object is stationary, determining a second location of the second object using a plurality of frames of the reflected chirps.

12. The method of claim 11,
wherein determining that the first object is moving comprises determining that a first estimated velocity of the first object is greater than a threshold level, and
wherein determining that the second object is stationary comprises determining that a second estimated velocity of the second object is greater than the threshold level.

13. The method of claim 11, wherein determining the second location comprises processing a subset of reflected chirps across the plurality of frames.

14. The method of claim 11, wherein determining the second location comprises processing a respective chirp from each frame of the plurality of frames.

15. The method of claim 11, further comprising running a time-division mode to interleave the processing of the single frame and the processing the plurality of frames.

16. The method of claim 11,
wherein the plurality of frames is a first plurality of frames, and
wherein the method further comprises:
refraining from processing a second plurality of frames of the reflected chirps for at least five frames after processing the first plurality of frames; and
processing the second plurality of frames to determine the second location at least five frames after processing the first plurality of frames.

17. The method of claim 11, further comprising:
identifying, in the plurality of frames, a set of points having a first velocity exceeding a threshold level;
removing the set of points from a point cloud; and
detecting the second location based on the point cloud.

18. The method of claim 17, wherein the set of points is first set of points, and wherein the method further comprises:
identifying, in the plurality of frames, a second set of points having a second velocity not exceeding the threshold level;
identifying, in the single frame, a third set of points; and
adding the second and third sets of points to the point cloud.

19. The method of claim 11, further comprising:
detecting a first number of objects using the single frame;
detecting a second number of objects using the plurality of frames;
determining a difference between the first and second numbers exceeds a threshold level; and
responsive to determining that the difference exceeds the threshold level, increasing a confidence level for setting a new track.

20. A device comprising:
a radar sensor configured to transmit a plurality of frames of chirps; and
processing circuitry configured to:
responsive to the radar sensor transmitting each frame in the plurality of frames of chirps, increment a counter value;
determine whether the counter value equals a predetermined value;
responsive to determining that the counter value does not equal the predetermined value, run a single-frame processing mode on a most recent frame of the plurality of frames;
responsive to determining that the counter value equals the predetermined value, run a multi-frame processing mode on the plurality of frames; and
after running the multi-frame processing mode, reset the counter value.
